(19) United States
(12) Patent Application Publication
(10) Pub. No.: US 2014/0018279 A1
(43) Pub. Date: Jan. 16, 2014

(54) DISHWASHING COMPOSITIONS CONTAINING AN ESTERIFIED SUBSTITUTED BENZENE SULFONATE

(71) Applicants: Xinbei Song, Cincinnati, OH (US); Jeffrey Scott DuPont, Cincinnati, OH (US); Jeffrey John Scheibel, Glendale, OH (US); Scott Leroy Cron, Liberty Township, OH (US)

(72) Inventors: Xinbei Song, Cincinnati, OH (US); Jeffrey Scott DuPont, Cincinnati, OH (US); Jeffrey John Scheibel, Glendale, OH (US); Scott Leroy Cron, Liberty Township, OH (US)

(21) Appl. No.: 13/546,315

(22) Filed: Jul. 11, 2012

(51) Int. Cl. C11D 3/60; C11D 17/00

(52) U.S. Cl. 510/224; 510/228

(57) ABSTRACT

Automatic dishwashing detergent compositions containing an esterified benzene sulfonate, a peroxide source, and a non-ionic surfactant provide a “3-in-1” benefit of red stain removal on plastics, tea stains on ceramics, and corrosion inhibition on metals.

### FIELD OF THE INVENTION

The present invention is in the field of dishwashing. In particular, it relates to an automatic dishwashing detergent composition.

### BACKGROUND OF THE INVENTION

A frequent problem in automatic dishwashing is the presence of stains on dishware even after being washed. Especially hard to remove from dishware are stains such as red stains (e.g. tomatoes, ketchup) on plastics and tea stains on ceramics. Bleach may be added to the composition to help in stain removal, but because of the varying stains and surfaces of dishware, multiple and varying components need to be added to clean a wide variety of surfaces and stains. This adds cost and formulation complexity.

Another problem in automatic dishware washing is the corrosion of aluminum dishware during the dishwashing cycle. This problem is more pronounced in phosphate free compositions. It is believed that phosphate forms a thin protective layer on the surface of metal dishware to help protect the dishware from oxidation and subsequent corrosion. In phosphate free formulations, there is a need to provide corrosion inhibition on metal dishware.

Accordingly, there is a need for an automatic dishwashing detergent composition that is able to clean varying dishware surfaces such as plastics, ceramics, and metals. In addition, there is a need for a component in an automatic dishwashing detergent composition that is also capable of providing the three benefits of red stain removal on plastics, tea stain removal on ceramics, and corrosion inhibitor on aluminium. Furthermore, there is a need for an automatic dishwashing detergent composition formulation that minimizes components to provide a simple and cost effective formula for cleaning.

### SUMMARY OF THE INVENTION

The present invention relates to a method of cleaning dishware comprising the step of treating the dishware with a composition comprising: (a) an esterified benzene sulfonate having the general structure:

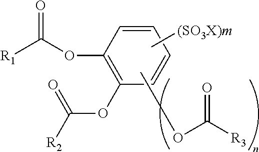

wherein R1 is selected from hydrogen or a C₁-C₁₁ alkyl; R₂ is selected from hydrogen or a C₁-C₁₁ alkyl, R₃ is selected from hydrogen or a C₁-C₁₁ alkyl, m is selected from 1 or 2, n is selected from 0 to 3, and X is a water soluble cation; (b) from about 0.5% to about 15% by weight of the composition of a peroxide source; and (c) from about 0.1% to about 10% by weight of the composition of a non-ionic surfactant.

An automatic dishwashing detergent composition comprising (a) an esterified benzene sulfonate having the structure:

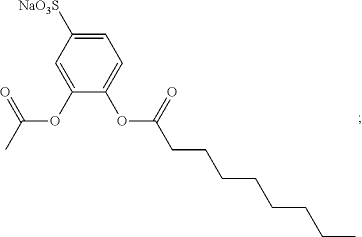

(b) from about 0.5% to about 15% by weight of the composition of a peroxide source; (c) from about 1% to about 10% by weight of the composition of a non-ionic surfactant; and (d) from about 0.5% to about 20% by weight of the composition of a polymer wherein the polymer comprises a carboxylic acid monomer and a sulphonate containing monomer.

An automatic dishwashing article comprising: (a) a water soluble pouch containing a composition, wherein the composition comprises: i. an esterified benzene sulfonate having the general structure:

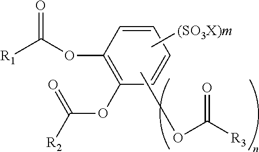

wherein R1 is selected from hydrogen or a C₁-C₁₁ alkyl; R₂ is selected from hydrogen or a C₁-C₁₁ alkyl, R₃ is selected from hydrogen or a C₁-C₁₁ alkyl, m is selected from 1 or 2, n is selected from 0 to 3, and X is a suitable water soluble cation; ii. from about 0.5% to about 15% by weight of the composition of a peroxide source; and iii. from about 0.1% to about 10% by weight of the composition of a non-ionic surfactant.

Methods of washing dishware in automatic dishwashing machines with these compositions and articles are also provided. In one embodiment, the aforementioned compositions or articles are administered to the dosing receiver of an automatic dishwashing machine.

### DETAILED DESCRIPTION OF THE INVENTION

In all embodiments of the invention, all percentages are by weight of the total composition, unless specifically stated otherwise. All ratios are weight ratios, unless specifically stated otherwise. All ranges are inclusive and combinable. The number of significant digits conveys neither a limitation on the indicated amounts nor on the accuracy of the measurements. All numerical amounts are understood to be modified by the word “about” unless otherwise specifically indicated. All such weights as they pertain to listed ingredients are based on the active level and do not include carriers or by-products that may be included in commercially available materials, unless otherwise specified.

It should be understood that every maximum numerical limitation given throughout this specification would include every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

Consumers desire an automatic dishwashing detergent composition that is able to clean varying dishware surfaces such as plastics, ceramics, and metals. In addition, there is a need for a single component providing three benefits to dishware (i.e. three benefits in a single component) of red stain removal on plastics, tea stain removal on ceramics, and corrosion inhibition on aluminum.

It has been surprisingly found that when esterified substituted benzene sulfonates are combined with a source of peroxide in an automatic dishwashing aqueous wash liquor, peracid sources and catechols are generated which provide three benefits of red stain removal on plastics, tea stain removal on ceramics, and corrosion inhibition on aluminum ware.

When diester catechol sulfonate is combined with a peroxide source, two organic peracid sources are generated. A first organic peracid is pernonanoic acid (PNA) which has the benefit of red stain removal from plastics. Without wishing to be bound by theory, PNA is able to remove red stains from plastics due to the fact that as a hydrophobic peracid, it is attracted to the hydrophobic surface of the plastic. Once on the surface of the plastic, PNA is able to bleach out the red stain found on the plastic dishware. Since other bleaches, such as peroxides, are generally not hydrophobic they are not able to successfully remove the red stains from the plastic.

The diester catechol sulfonate also generates peracetic acid that improves tea cleaning on ceramics. Peracetic acid oxidizes tea stains to make the stains more soluble in water for removal from ceramic surfaces.

Diester catechol sulfonate generates catechol sulfonates. It has been surprisingly found that these catechol sulfonates act as corrosion inhibitors for metal dishware. In one embodiment, the diester catechol is 1,2-dihydroxybenzene-3,5-disulfonate (Tiron). Tiron is a cleaved molecule. Without wishing to be bound by theory, this molecule has a high aluminum affinity due to the adjacent (OH) groups on the benzene ring, thereby providing a protective barrier on the surface against corrosion.

### Esterified Substituted Benzene Sulfonate

The present invention relates to an automatic dishwashing detergent composition comprising an esterified substituted benzene sulfonate having the general structure:

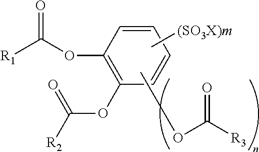

wherein R1 is selected from hydrogen or a C₁-C₁₁ alkyl; R₂ is selected from hydrogen or a C₁-C₁₁ alkyl; R₃ is selected from hydrogen or a C₁-C₁₁ alkyl; and X is a suitable water soluble cation. For the purposes of this invention, alkyls can be substituted or unsubstituted alkyls. R₁ can be the same or different from R₂. R₁ and R₂ can be the same or different from R₃, n is selected from 0 to 3, m is selected from 1 to 3.

The esterified substituted benzene sulfonate may be selected as an esterified benzene sulfonate having the general structure:

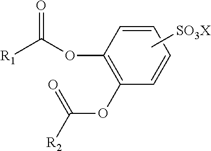

wherein R₁ is selected from hydrogen or a C₁-C₁₁ alkyl; R₂ is selected from hydrogen or a C₁-C₁₁ alkyl; and X is a suitable water soluble cation. R₁ can be the same or different from R₂. In one embodiment, R₁ and R₂ are CH3 (C1 alkyl), such as 1,2 di-acetoxy benzene-4 sodium sulfonate. In a second embodiment, R₁ and R₂ are a C9 alkyl, such as 4-sodium sulfocatechol-dinonate. The sulfonate moiety may be substituted on the benzene ring on any of the 1-6 positions. In one embodiment shown below, the sulfonate moiety is located at the 4 position of the benzene ring having X as a sodium cation.

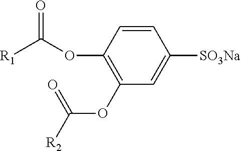

In another embodiment shown below, the esterified benzene sulfonate is a disulfonate having a SO₃ in the 3 and 5 positions of the benzene ring:

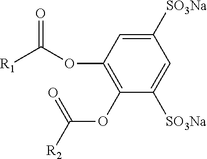

Another embodiment includes R₁ as a CH3 (C1 alkyl) and R₂ as a CH3 (C₁ alkyl). Another embodiment includes R₁ as C8 alkyl and R₂ as C8 alkyl. Mixtures of the esterified benzene sulfonate may be utilized as well. In one embodiment a mixture of diesterified benzene sulfonate wherein R₁ is CH3 and R₂ is a C9 alkyl is mixed with R₁ being selected a C9 alkyl.

In one embodiment, the esterified substituted benzene sulfonate is essentially free of catechol (1,2-benzenediol). As used herein, “essentially free” means less than about 3 wt %, or less than about 2 wt %, or less than about 1 wt %, or from about 1% to about 0 wt %, by weight of the automatic dishwashing composition of catechol is present.

An esterified benzene sulfonate is made through the steps of: (a) esterifying a cis-polyhydroxybenzene with a carboxylic acid or carboxylic acid derivative to form an esterified benzene; (b) sulfonating the esterified benzene to form an esterified benzene sulfonate acid; and (c) neutralizing the esterified benzene sulfonate acid to form an esterified benzene sulfonate. Carboxylic acid derivatives include but are not limited to acid halides, acid anhydrides and esters. The process of making an esterified benzene sulfonate is discussed in, for example, U.S. Pat. No. 7,892,362.

The esterified benzene sulfonate is added to the automatic dishwashing detergent composition in an amount from about 0.1% to about 50%, in another embodiment from about 5% to about 35%, in another embodiment from about 5% to about 15% by weight of the composition.

### Peroxide Source

The esterified benzene sulfonate may be utilized in automatic dishwashing detergent compositions which also comprise a source of peroxide that triggers the separation of the esterified benzene sulfonate into the corresponding C₂-C₁₂ percarboxylic acid and benzene-1,2-dihydroxy sulfonate. When used in an automatic dishwashing machine during a wash cycle, suitable peroxide sources include, but are not limited to percarbonate, perborate, persilicate, hydrogen peroxide adducts and hydrogen peroxide. The triggering peroxide source material, when present, comprises from about 0.5% to about 15%, by weight of the automatic dishwashing detergent composition. Certain embodiments of the automatic dishwashing detergent composition comprise from about 1% to about 10% of the peroxide source. The peroxide source material may be added to the automatic dishwashing detergent composition directly or it may be added in a form where early formation of peroxide and resulting premature separation of the esterified benzene sulfonate is prevented or minimized, such as by adding the peroxide source in an encapsulated form. Alternatively, an article comprising the compositions of the present invention can be divided in to two or more components wherein the components are contained in two or more compartments of the article. For example, a first compartment may contain esterified benzene sulfonated-containing component and a second compartment may contain the peroxide source-containing component. This way, these components are separated thereby preventing the premature separation of the esterified benzene sulfonate.

### Bleach

In addition to a peroxide source, inorganic and organic bleaches may be added to the composition as suitable cleaning actives. Alternatively, the compositions of the present invention are free or essentially free of these bleaches. Bleaches listed herein may also provide a peroxide function. Inorganic bleaches include perhydrate salts such as perborate, percarbonate, perphosphate, persulfate and persilicate salts. The inorganic perhydrate salts are normally the alkali metal salts. The inorganic perhydrate salt may be included as the crystalline solid without additional protection. Alternatively, the salt can be coated.

Alkali metal percarbonates, particularly sodium percarbonate are perhydrates for use herein. The percarbonate is incorporated into the products in a coated form which provides in-product stability. A suitable coating material providing in product stability comprises mixed salt of a water-soluble alkali metal sulphate and carbonate. Such coatings together with coating processes have previously been described, for example, in GB-1,466,799. The weight ratio of the mixed salt coating material to percarbonate lies in the range from 1:200 to 1:4, in another embodiment from 1:99 to 1:9, and in another embodiment from 1:49 to 1:19. In one embodiment, the mixed salt is of sodium sulphate and sodium carbonate which has the general formula Na₂S0_{4.n}Na₂CO₃ wherein n is from 0.1 to 3, in one embodiment n is from 0.3 to 1.0 and in another embodiment n is from 0.2 to 0.5.

Another suitable coating material providing product stability comprises sodium silicate of Si0₂:Na20 ratio from 1.8:1 to 3.0:1, in another embodiment L8:1 to 2.4:1, and/or sodium metasilicate, applied at a level of from 2% to 10%, (normally from 3% to 5%) of Si0₂ by weight of the inorganic perhydrate salt. Magnesium silicate can also be included in the coating. Coatings that contain silicate and borate salts or boric acids or other inorganics are also suitable. Other coatings which contain waxes, oils, fatty soaps can also be used advantageously within the present invention. Potassium peroxymonopersulfate is another inorganic perhydrate salt.

Typical organic bleaches are organic peroxyacids including diacyl and tetraacylperoxides, especially diperoxydodecanedioc acid, diperoxytetradecanedioc acid, and diperoxyhexadecanedioc acid. In one embodiment, dibenzoyl peroxide is an organic peroxyacid herein.

If used, the diacyl peroxide, especially dibenzoyl peroxide, should be present in the form of particles having a weight average diameter of from about 0.1 to about 100 microns, in another embodiment from about 0.5 to about 30 microns, and in another embodiment from about 1 to about 10 microns. In one embodiment, at least about 25% of the particles are smaller than 10 microns, in another embodiment at least about 50%, in another embodiment at least about 75%, and in another embodiment at least about 90%. Diacyl peroxides within the above particle size range have also been found to provide better stain removal especially from plastic dishware, while minimizing undesirable deposition and filming during use in automatic dishwashing machines, than larger diacyl peroxide particles. The diacyl peroxide particle size thus allows the formulator to obtain good stain removal with a low level of diacyl peroxide, which reduces deposition and filming. Conversely, as diacyl peroxide particle size increases, more diacyl peroxide is needed for good stain removal, which increases deposition on surfaces encountered during the dishwashing process.

Further typical organic bleaches include the peroxy acids, particular examples being the alkylperoxy acids and the arylperoxy acids. Representatives are (a) peroxybenzoic acid and its ring-substituted derivatives, such as alkylperoxybenzoic acids, but also peroxy-α-naphthoic acid and magnesium monoperphthalate, (b) the aliphatic or substituted aliphatic peroxy acids, such as peroxylauric acid, peroxystearic acid, ε-phthalimidoperoxycaproic acid[phthaloiminoperoxyhexanoic acid (PAP)], o-carboxybenzamidoperoxycaproic acid, N-nonenylamidoperadipic acid and N-nonenylamidopersuccinates, and (c) aliphatic and araliphatic peroxydicarboxylic acids, such as 1,12-diperoxycarboxylic acid, 1,9-diperoxyazelaic acid, diperoxysebacic acid, diperoxybrassylic acid, the diperoxyphthalic acids, 2-decyldiperoxybutane-1,4-dioic acid, N,N-terephthaloyldi(6-aminopercaproic acid).

In one embodiment, the composition of the invention contains percarbonate. In another embodiment, the composition comprises sodium percarbonate.

### Bleach Activators

Bleach activators are typically organic peracid precursors that enhance the bleaching action in the course of cleaning at temperatures of 60° C. and below. Bleach activators suitable for use herein include compounds which, under perhydrolysis conditions, give aliphatic peroxoycarboxylic acids having from 1 to 10 carbon atoms, in particular from 2 to 4 carbon atoms, and/or optionally substituted perbenzoic acid. Suitable substances bear O-acyl and/or N-acyl groups of the number of carbon atoms specified and/or optionally substituted benzoyl groups. In one embodiment the bleach activator is polyacylated alkylenediamines, in particular tetraacetylethylenediamine (TAED), acylated triazine derivatives, in particular 1,5-diacetyl-2,4-dioxohexahydro-1,3,5-triazine (DADHT), acylated glycolurils, in particular tetraacetylglycoluril (TAGU), N-acylimides, in particular N-nonanoylsuccinimide (NOSI), acylated phenolsulfonates, in particular n-nonanoyl- or isononanoyloxybenzenesulfonate (n- or iso-NOBS), carboxylic anhydrides, in particular phthalic anhydride, acylated polyhydric alcohols, in particular triacetin, ethylene glycol diacetate and 2,5-diacetoxy-2,5-dihydrofuran and also triethylacetyl citrate (TEAC). Bleach activators, if included in the compositions of the invention, are present in a level of from about 0.002% to about 5%, in another embodiment from about 0.005% to about 0.022% by weight of the total composition.

### Bleach Catalyst

Bleach catalysts for use herein include the manganese triazacyclononane and related complexes (U.S. Pat. No. 4,246,612, U.S. Pat. No. 5,227,084); Co, Cu, Mn and Fe bispyridylamine and related complexes (U.S. Pat. No. 5,114,611); and pentamine acetate cobalt(III) and related complexes (U.S. Pat. No. 4,810,410). A complete description of bleach catalysts suitable for use herein can be found in U.S. Pat. No. 7,084,102, pages 34, line 26 to page 40, line 16. Bleach catalyst, if included in the compositions of the invention, are present in a level of from about 0.1% to about 10%, in another embodiment from about 0.5% to about 2% by weight of the total composition.

In one embodiment, the composition is contains a peroxide source but is substantially free of bleach, bleach activators, bleach catalysts, and mixtures thereof. In another embodiment, the composition contains less than 5% by weight of the composition of bleach, in another embodiment less than 1% by weight of the composition of bleach, in another embodiment less than 0.01% by weight of the composition of bleach.

### Cleaning Actives

Any traditional cleaning ingredients can be used as part of the automatic dishwashing detergent composition. The levels given are weight percent and refer to the total composition (excluding the enveloping water-soluble material). The cleaning product can contain a builder or be free of builder and comprise one or more detergent active components which may be selected from surfactants, alkalinity sources, enzymes, polymers, anti-corrosion agents (e.g. sodium silicate) and care agents. In one embodiment, the automatic dishwashing detergent composition includes a builder compound, an alkalinity source, a surfactant, a polymer (in one embodiment a sulfonated polymer), an enzyme, and an additional bleaching agent.

### Polymer

A variety of polymers may be used in the automatic dishwashing detergent composition. In one embodiment, the polymer is formed by at least one or more of the following monomers: (i) a carboxylic acid containing monomer; (ii) a sulfonic acid group containing monomer; and (iii) optionally further an ionic or non-ionic monomer.

Suitable polymers with sulfonated/carboxylated monomers described herein may have a weight average molecular weight of less than or equal to about 100,000 Da, or less than or equal to about 75,000 Da, or less than or equal to about 50,000 Da, or from about 3,000 Da to about 50,000, in another embodiment from about 4,500 Da to about 20,000 Da, alternatively from about 5,000 Da to about 15,000 Da, in another embodiment about 8,500 Da.

The polymer is present in the automatic dishwashing detergent composition in an amount from about 0.5% to about 50%, in another embodiment from about 5% to about 35%, in another embodiment from about 5% to about 15% by weight of the total composition. A description of polymers suitable for use herein can be found in U.S. 2011/000903, page 2, line 4 to page 8, line 25, and in U.S. Pat. No. 7,892,362, column 6, line 35 to column 17, line 25.

In one embodiment, the polymer is selected to have one or more copolymers of unsaturated or saturated carboxylic acid monomers. Carboxylic acid monomers include one or more of the following: acrylic acid, maleic acid, itaconic acid, methacrylic acid, or ethoxylate esters of acrylic acids, acrylic and methacrylic acids. In one embodiment, the carboxylic acid is (meth)acrylic acid.

In another embodiment, the polymer is selected to have one or more monomers containing sulfonic acid groups. Sulfonated monomers include one or more of the following: sodium (meth) allyl sulfonate, vinyl sulfonate, sodium phenyl (meth) allyl ether sulfonate, or 2-acrylamido-methyl propane sulfonic acid. In one embodiment, the unsaturated sulfonic acid monomer is most 2-acrylamido-2-propanesulfonic acid (AMPS). In another embodiment, the unsaturated sulfonic acid monomer is 3-allyloxy-2-hydroxy-1-propanesulfonate (HAPS).

In a further embodiment, the polymer is selected to include ionic or non-ionic monomers. Non-ionic monomers include one or more of the following: methyl (meth)acrylate, ethyl (meth) acrylate, t-butyl (meth)acrylate, methyl (meth) acrylamide, ethyl (meth) acrylamide, t-butyl (meth) acrylamide, styrene, or α-methyl styrene.

In one embodiment, the polymer comprises the following levels of monomers: from about 40 to about 90%, in another embodiment from about 60 to about 90% by weight of the polymer of one or more carboxylic acid monomer; from about 5 to about 50%, in another embodiment from about 10 to about 40% by weight of the polymer of one or more sulfonic acid monomer; and optionally from about 1% to about 30%, in one embodiment from about 2 to about 20% by weight of the polymer of one or more non-ionic monomer. In one embodiment the polymer comprises about 70% to about 80% by weight of the polymer of at least one carboxylic acid monomer and from about 20% to about 30% by weight of the polymer of at least one sulfonic acid monomer.

Examples of commercially available polymers include: Acusol 587G and Acusol 588G supplied by Rohm & Haas and those described in U.S. Pat. No. 5,308,532 and in U.S. Pat. No. 7,879,154. Acusol 588 is sourced from Dow (which acquired Rohm and Haas).

In another embodiment, the polymer is GT-101. GT101 is sourced from Nippon Shokubai. A complete description of GT101 and similar polymers appear in U.S. 2011/0009303 at page 2, line 3 through page 7 line 25.

### Builder

Builders for use herein include amino acid based builders. Builders are used in a level of from about 1% to about 60%, in another embodiment from about 5% to about 50%, in another embodiment from about 15% to about 30% by weight of the composition.

Amino acid based builders include MGDA (methyl-glycine-diacetic acid), and salts and derivatives thereof and GLDA (glutamic-N,N-diacetic acid) and salts and derivatives thereof. GLDA (salts and derivatives thereof) is included in one embodiment, more specifically the tetrasodium salt. In one embodiment, the composition is free or substantially free of phosphate builders. Other suitable builders are described in U.S. Pat. No. 6,426,229.

### Surfactant

The dishwashing detergent composition may comprise a non-ionic surfactant or a non-ionic surfactant system. In one embodiment, the non-ionic surfactant or the non-ionic surfactant system has a phase inversion temperature, as measured at a concentration of 1% in distilled water, of between 40 and 70° C., in another embodiment between 45 and 65° C. By a “non-ionic surfactant system” is meant herein a mixture of two or more non-ionic surfactants. In one embodiment, the automatic dishwashing detergent composition is substantially free of anionic and zwitterionic surfactants.

Surfactants may be present in amounts from 0% to 10% by weight, in another embodiment from 0.1% to 10%, in another embodiment from about 1% to about 8%, and another embodiment from 0.25% to 6% by weight of the total composition. In one embodiment, the product of the invention comprises from 0.1 to 10% of non-ionic surfactant wherein at least 50%, in another embodiment at least 60% of the total amount of non-ionic surfactant is in the aqueous composition.

Suitable nonionic surfactants include: i) ethoxylated non-ionic surfactants prepared by the reaction of a monohydroxy alkanol or alkyphenol with 6 to 20 carbon atoms with at least 12 moles, in another embodiment at least 16 moles, and in another embodiment at least 20 moles of ethylene oxide per mole of alcohol or alkylphenol; ii) alcohol alkoxylated surfactants having a from 6 to 20 carbon atoms and at least one ethoxy and propoxy group. In one embodiment are mixtures of surfactants i) and ii).

### Silicates

Silicates, if present, are at a level of from about 1% to about 20%, in one embodiment from about 5% to about 15% by weight of the composition. In one embodiment, silicates are sodium silicates such as sodium disilicate, sodium metasilicate and crystalline phyllosilicates.

### Enzyme

Suitable enzymes for use in the automatic dishwashing detergent composition include proteases such as metalloproteases and serine proteases. Suitable proteases include those of animal, vegetable or microbial origin. Chemically or genetically modified mutants are included.

Commerically available protease enzymes include those sold under the trade names Alcalase®, Savinase®, Primase®, Durazym®, Polarzyme®, Kannase®, Liquanase®, Ovozyme®, Neutrase®, Everlase® and Esperase® by Novo Nordisk A/S (Denmark), those sold under the tradename Maxatase®, Maxacal®, Maxapem®, Properase®, Purafect®, Purafect Prime®, Purafect Ox®, FN3®, FN4®, Purafect OXP® and Excellase® by Genencor International, and those sold under the tradename Opticlean® and Optimase® by Solvay

In one embodiment, the cleaning product of the invention comprises at least 0.001 mg of active protease. In further embodiments, the composition comprises a high level of protease, in particular at least 0.1 mg of active protease per gram of composition. In one embodiment, levels of protease in the compositions of the invention include from about 1.5 to about 10, in another embodiment from about 1.8 to about 5, and in another embodiment from about 2 to about 4 mg of active protease per gram of composition.

In another embodiment, the enzyme is an amylase. Suitable alpha-amylases include those of bacterial or fungal origin. Chemically or genetically modified mutants (variants) are included.

In one embodiment, amylases are NATALASE®, STAINZYME® and STAINZYME PLUS® and mixtures thereof.

In one embodiment, the composition comprises at least 0.001 mg of active amylase. In one embodiment high level of amylase is used, at least 0.05 mg of active amylase per gram of composition, in another embodiment from about 0.1 to about 10, in another embodiment from about 0.25 to about 6, in another embodiment from about 0.3 to about 4 mg of active amylase per gram of composition. A complete description of enzymes suitable for use herein can be found in U.S. Pat. No. 7,892,362, column 6, line 35 to column 17, line 25.

### Alkalinity

Examples of alkalinity source include, but are not limited to, an alkali hydroxide, alkali hydride, alkali oxide, alkali sesquicarbonate, alkali carbonate, alkali borate, alkali salt of mineral acid, alkali amine, alkaloid and mixtures thereof. In one embodiment, the alkalinity source is sodium carbonate, in another embodiment sodium hydroxide, in another embodiment potassium hydroxide. The alkalinity source may be present in an amount sufficient to give the wash liquor a pH of from about 8 to about 12, more preferably from about 9 to about 11.5. The composition herein may comprise from about 1% to about 40%, more preferably from about 2% to 20% by weight of the composition of alkaline source.

### Water-Soluble Pouch

In one embodiment, the product of the invention is a unit-dose product. Products in unit dose form include tablets, capsules, sachets, pouches, etc. In one embodiment, the unit dose is contained in a water-soluble film (including tablets, capsules, sachets, pouches). In one embodiment, the product is in the form of a water soluble pouch.

In one embodiment, the composition of the invention is contained in a water-soluble film pouch or a water soluble injection molded pouch. Examples of injection molded pouches can be found in U.S. 2011/0175257. The weight of the composition of the invention contained in the pouch is from about 10 to about 35 grams, in one embodiment from about 12 to about 26 grams, and in another embodiment from 14 to 22 grams. In the cases of unit dose pouches having a water-soluble material containing the detergent composition, the water-soluble material is not considered part of the composition.

In one embodiment, the pouches comprise one compartment. In another embodiment, the pouches comprise at least two side-by-side compartments to form multi-compartment pouches. In one embodiment, the two compartments are superposed to one another. The compartments contain components of a single claimed composition herein. Examples of multi-compartment pouches and the methods of making them can be found in U.S. Pat. No. 7,125,828.

In one embodiment, at least one of the compartments contains a powder component and the other compartment contains a non-powder component. Non-powder components can be in the form of a gel or a liquid. The powder component can be compressed powder or non-compressed powder or mixtures thereof. In one embodiment, at least one of the compartments contains a solid composition and another compartment contains a non-solid composition. In another embodiment, at least one of the compartments contains a solid composition and another compartment contains an aqueous liquid composition. The compartments can have the same or varying weight ratios.

In one embodiment, the two side-by-side compartments contain liquid compositions. In another embodiment, the compartments contain different compositions, and at least one compartment contains a solid composition. In one embodiment the solid composition is in powder form, specifically a densified powder. The solid composition contributes to the strength and robustness of the pack. In one embodiment, at least one compartment contains a multiphase composition.

In one embodiment, the pouch has an overall volume of from about 5 to about 70 ml, in another embodiment from about 15 to about 60 ml, in another embodiment from about 18 to 57 ml, and a longitudinal/transverse aspect ratio in the range from about 2:1 to about 1:8, in another embodiment from about 1:1 to about 1:4. The longitudinal dimension is defined as the maximum height of the pouch when the pouch is lying on one of the bases which has the maximum footprint with the pouch compartments superposed in a longitudinal direction, i.e. one over another, and under a static load of about 2 Kg. The transverse dimension is defined as the maximum width of the pouch in a plane perpendicular to the longitudinal direction under the same conditions. These dimensions are adequate to fit the dispensers of the majority of dishwashers. Although the shape of the pouch can vary widely, in order to maximize the available volume, pouches should have a base as similar as possible to the footprint of the majority of the dispensers, that is generally rectangular.

The enzymes can lose stability in the composition due to their interactions with bleach and builders (they can destabilize the enzyme by binding to the calcium of the enzymes). In addition, the performance of enzymes in a composition can be impaired by the alkalinity of the solution, bleach, builders, etc. In one embodiment, the solid composition comprises bleach and the liquid composition comprises enzymes. In one embodiment one of the films enclosing the enzyme-comprising composition dissolves prior to the films enclosing the bleach-containing composition during the main-wash cycle of the automatic dishwashing machine, thereby releasing the enzyme-containing composition into the wash liquor prior to the delivery of the bleach-containing composition. This gives the enzymes the possibility to operate under optimum conditions, avoiding interactions with other detergent actives.

Controlled release of the ingredients of the multi-compartment pouch can be achieved by modifying the thickness of the film and/or the solubility of the film material. The solubility of the film material can be delayed by, for example, cross-linking the film as described in WO 02/102,955 at pages 17 and 18. Other water-soluble films designed for rinse release are described in U.S. Pat. No. 4,765,916 and U.S. Pat. No. 4,972,017.

Other means of obtaining delayed release by multi-compartment pouches with different compartments, where the compartments are made of films having different solubility are taught in WO 02/08380.

### EXAMPLES

TABLE I
Automatic Dishwashing Cleaning composition Gel and Powder

| | Gel (wt %) | Powder (wt %) |
|---|---|---|
| Polygel DKP¹ | 1-2 | — |
| SLF-18 poly-tergent² | 0-2 | 0.5-2 |
| Alcosperse 246³ | — | 0-5 |
| Esterified substituted | 0.1-6 | 0.1-6 |
| benzene sulfonate⁴ | | |
| Polymer⁵ | 0.2-6 | 0.2-6 |
| Hydrozincite | 0-0.3 | — |
| Zinc sulfate | 0-0.8 | — |
| Nitric acid (70%) | 0.01-0.05 | — |
| Sulfuric acid | 0-5 | — |
| NaOH | 0-4 | — |
| KOH | 0-15 | — |
| Carbonate | — | 25-35 |
| 2.0 silicate | 0-20 | 7-15 |
| Sodium hypochloride | 0-8 | — |
| Enzyme system⁶ | 0-1 | 0.5-3 |
| 1,2-propanediol | 0-1 | — |
| Boric acid | 0-4 | — |
| Sodium perborate monohydrate | 2-6 | 2-6 |
| Calcium chloride | 0-0.5 | — |
| Sodium benzoate | 0.1-6 | — |
| Sodium sulfate | — | 20-35 |
| Water, perfume and other | Balance to | Balance to |
| components | 100% | 100% |

¹polyacrylate thickener
²linear alcohol ethoxylate from Olin Corporation
³sulfonated copolymer of acrylic acid from Alco Chemical Co.
⁴such as those described above
⁵an polymer such as those described above
⁶one or more enzymes such as protease, amylase, and mixture thereof.

TABLE II
Automatic Dishwashing Two-Compartment Unit Dose

| | |
|---|---|
| | Powder (wt % based |
| | on 1.9 g portion) |
| Alcosperse¹ | 7-12 |
| SLF-18 Polytergent² | 1-2 |
| Esterified substituted benzene sulfonate³ | 0.1-6.0 |
| Polymer⁴ | 0.2-6.0 |
| Sodium perborate monohydrate | 2-6 |
| Carbonate | 20-30 |
| 2.0r silicate | 5-9 |
| Sodium disilicate | 0-3 |
| Enzyme system⁵ | 0.1-5.0 |
| Pentaamine cobalt(III)chloride salt | 10-15 |
| TAED | 0-3 |
| Perfume, dyes, water and other components | Balance to 100% |
| | Liquid (wt % based |
| | on 1.9 g portion) |
| Dipropylene Glycol | 35-45 |
| SLF-19 Polytergent² | 40-50 |
| Neodol ® C11EO9 | 1-3 |
| Dyes, water and other components | Balance to 100% |

¹Alcosperse ® 246 or 247, a sulfonated copolymer of acrylic acid from Alco Chemical Co.
²linear alcohol ethoxylate from Olin Corporation
³such as those described above
⁴a sulfonated polymer such as those described above
⁵one or more enzymes such as protease, amylase, and mixture thereof

As used herein, the article “a” means at least one or one or more, unless it is specifically defined to mean otherwise. All numerical quantities are understood to be modified by the word “about,” unless specifically noted otherwise or unless an exact amount is needed to define the invention over the prior art.

Every document cited herein, including any cross referenced or related patent or application is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A method of cleaning dishware comprising the step of treating the dishware with a composition comprising:
(a) an esterified benzene sulfonate having the general structure: 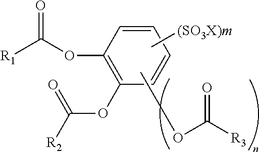
wherein R₁ is selected from hydrogen or a C₁-C₁₁ alkyl; R₂ is selected from hydrogen or a C₁-C₁₁ alkyl, R₃ is selected from hydrogen or a C₁-C₁₁ alkyl, m is selected from 1 or 2, n is selected from 0 to 3, and X is a water soluble cation;
(b) from about 0.5% to about 15% by weight of the composition of a peroxide source; and
(c) from about 0.1% to about 10% by weight of the composition of a non-ionic surfactant.

2. The method of claim 1, wherein the esterified benzene sulfonate is present from about 0.1% to about 50% by weight of the composition.

3. The method of claim 2, wherein the esterified substituted benzene sulfonate is essentially free of 1,2-benzenediol.

4. The method of claim 3, wherein the esterified benzene sulfonate is: 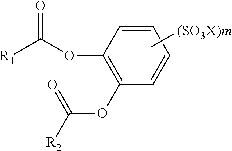
wherein R₁ is selected from hydrogen or a C₁-C₁₁ alkyl; R₂ is selected from hydrogen or a C₁-C₁₁ alkyl; m is selected from 1 or 2, wherein the sulfonate moieties may be located on the 1, 2, 3, or 6 positions on the benzene ring; and X is a suitable water soluble cation.

5. The method of claim 4, wherein the esterified benzene di-sulfonate is selected such that R₁ and R₂ are each independently selected from a C₁ alkyl or a C₉ alkyl.

6. The method of claim 5, wherein the esterified benzene di-sulfonate is selected such that the sulfonate moieties are located at the 1 and 3 positions of the benzene ring and X is a sodium cation.

7. The method of claim 6, wherein the esterified benzene sulfonate is a mixture of a first esterified benzene sulfonate and a second esterified benzene sulfonate; wherein the first esterified benzene sulfonate comprises R₁ selected as a C₁ alkyl and R₂ is a C₉ alkyl; wherein the second esterified benzene sulfonate comprises R₁ as a C₉ alkyl and R₂ as a C₁ alkyl.

8. The method of claim 7, wherein the peroxide source is selected from the group consisting of percarbonate, perborate, persilicate, hydrogen peroxide adducts, hydrogen peroxide and mixtures thereof.

9. The method of claim 8, wherein the non-ionic surfactant is an epoxy-capped poly(oxyalkylated) alcohol.

10. The method of claim 9, wherein the composition is substantially free of anionic, zwitterionic, and amphoteric surfactants.

11. The method of claim 10, further comprising a builder, wherein the builder is selected from the group consisting of methyl-glycine-diatetic acid or a salt thereof, glutamic-N,N-diacetic acid or a salt thereof, and mixtures thereof.

12. The method of claim 11, wherein the builder is present in the composition from about 10% to about 50% by weight of the composition.

13. The method of claim 12, further comprising an enzyme, wherein the enzyme is selected from the group consisting of a protease, amylase, and mixtures thereof.

14. The method of claim 13, wherein the enzyme is present in the composition from about 0.001 mg to about 10 mg.

15. The method of claim 14, further comprising a source of alkalinity, wherein the source of alkalinity is sodium carbonate or potassium carbonate, and wherein the source of alkalinity is present from about 2% to about 20% by weight of the composition.

16. The method of claim 15, further comprising a polymer wherein the polymer is formed by at least the following monomers:
i.) a carboxylic acid containing monomer;
ii.) a sulfonic acid group containing monomer; and
iii.) optionally further an ionic or non-ionic monomer.

17. An automatic dishwashing composition comprising
(a) an esterified benzene sulfonate having the structure: 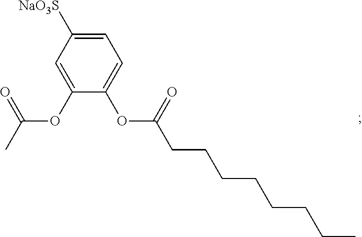
(b) from about 0.5% to about 15% of a peroxide source;
(c) from about 1% to about 10% by weight of the composition of a non-ionic surfactant; and
(d) from about 0.5% to about 20% of a polymer, wherein the polymer comprises a carboxylic acid monomer and a sulphonate containing monomer, and wherein the polymer comprises a molecular weight of from about 5,000 Da to about 15,000 Da.

18. The automatic dishwashing composition of claim 17, wherein the composition is contained in a water soluble pouch.

19. The automatic dishwashing composition of claim 18, wherein the water soluble pouch has multiple compartments, wherein at least one of the compartments comprises an enzyme and wherein at least another compartment comprises a bleach.

20. An automatic dishwashing article comprising:
(a) a water soluble pouch containing a composition, wherein the composition comprises:
i. an esterified benzene sulfonate having the general structure: 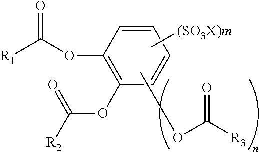
wherein R₁ is selected from hydrogen or a C₁-C₁₁ alkyl; R₂ is selected from hydrogen or a C₁-C₁₁ alkyl, R₃ is selected from hydrogen or a C₁-C₁₁ alkyl, m is selected from 1 or 2, n is selected from 0 to 3, and X is a suitable water soluble cation;
ii. from about 0.5% to about 15% by weight of the composition of a peroxide source; and
iii. from about 0.1% to about 10% by weight of the composition of a non-ionic surfactant.
